(19) United States
(12) Patent Application Publication
(10) Pub. No.: US 2014/0004412 A1
(43) Pub. Date: Jan. 2, 2014

(54) SECONDARY BATTERY

(71) Applicant: SEMICONDUCTOR ENERGY LABORATORY CO., LTD., Atsugi-shi (JP)

(72) Inventor: Kiyofumi OGINO, Atsugi (JP)

(21) Appl. No.: 13/905,163

(22) Filed: May 30, 2013

(30) Foreign Application Priority Data
Jun. 29, 2012 (JP) 2012-146716

(51) Int. Cl. H01M 4/40

(52) U.S. Cl. CPC H01M 4/405
USPC 429/199

(57) ABSTRACT

A secondary battery which can achieve battery performance satisfactorily in a low temperature environment in cold climates or the like is provided. Further, a secondary battery having high capacity even in a low temperature environment in cold climates or the like is provided. A secondary battery includes a positive electrode, a negative electrode, and an electrolyte solution which contains a nonaqueous solvent and an electrolyte. The negative electrode includes a negative electrode active material layer. The negative electrode active material layer contains graphene, a binder, and a negative electrode active material containing a particulate alloy-based material. The nonaqueous solvent contains propylene carbonate and the electrolyte contains lithium perchlorate.

### BACKGROUND OF THE INVENTION

1. Field of the Invention

The present invention relates to a secondary battery.

2. Description of the Related Art

In recent years, portable electronic devices such as mobile phones, smartphones, electronic book (e-book) readers, and portable game machines have come into wide use. Being used as power sources for driving these devices, secondary batteries typified by lithium secondary batteries have been researched and developed actively. Secondary batteries are of growing importance in a variety of uses; for example, hybrid electric vehicles and electric vehicles receive attention because of an increased interest in global environmental problems and an oil resources problem.

A lithium secondary battery, which is one of the secondary batteries and widely used because of its high energy density, includes a positive electrode including an active material such as lithium cobalt oxide (LiCoO₂) or lithium iron phosphate (LiFePO₄), a negative electrode formed of a carbon material such as graphite which is capable of occlusion and release of lithium ions, a nonaqueous electrolyte in which an electrolyte formed of a lithium salt such as LiBF₄ or LiPF₆ is dissolved in an organic solvent such as ethylene carbonate or diethyl carbonate, and the like. The lithium secondary battery is charged and discharged in such a way that lithium ions in the secondary battery move between the positive electrode and the negative electrode through the nonaqueous electrolyte and intercalated into or deintercalated from the positive electrode active material and the negative electrode active material.

Such a lithium secondary battery, however, has a problem in that discharge capacity thereof is markedly reduced particularly in a low temperature environment in cold climates (e.g., a subfreezing environment in winter) and thus, desired output cannot be provided. For this reason, a secondary battery which can be charged and discharged satisfactorily even in the low temperature environment is required for portable electronic devices expected to be used in the low temperature environment in the cold climates or the like. In the case of using the secondary battery as a power source of a motor in a hybrid electric vehicle, an electric vehicle, or the like that should be expected to be used in the cold climates, the secondary battery needs to have sufficiently high output characteristics.

Hence, to fully utilize the battery performance of the secondary battery with poor low-temperature characteristics, a heating circuit including a heating element of a nickel alloy or the like is directly formed over a positive electrode current collector with an insulating layer provided therebetween in Patent Document 1, for example. Thus, with a system for controlling battery temperature, battery operation can be ensured even in the low temperature environment.

In addition, secondary batteries are widely used as power sources for driving portable electronic devices, electric vehicles, and the like, and there is a very great need for more compact and higher capacity secondary batteries.

Thus, electrodes formed of an alloy-based material of silicon, tin, or the like, instead of a carbon material such as graphite (black lead) which has been conventionally used as a negative electrode active material, have been actively developed. A negative electrode used in a lithium secondary battery is fabricated by forming an active material on one surface of a current collector. Graphite that can occlude and release ions serving as carriers (hereinafter referred to as carrier ions) has been conventionally used as a negative electrode active material. In other words, the negative electrode has been fabricated in such a manner that graphite which is a negative electrode active material, carbon black as a conductive additive, and a resin as a binder are mixed to form slurry, and the slurry is applied to a current collector and dried.

On the other hand, in the case where an alloy-based material of silicon which is alloyed and dealloyed with lithium is used as a negative electrode active material, the negative electrode active material can occlude about four times as many carrier ions as a negative electrode active material using carbon. The negative electrode of carbon (graphite) has a theoretical capacity of 372 mAh/g, whereas the negative electrode of silicon has a dramatically high theoretical capacity of 4200 mAh/g, and therefore silicon is an optimal material for higher capacity secondary batteries.

However, as the number of occluded carrier ions increases, a change in the volume of an active material related to occlusion and release of carrier ions in charge and discharge cycles increases, resulting in lower adhesion between a current collector and silicon and deterioration of battery characteristics due to charge and discharge. Moreover, in some cases, a serious problem is caused in that silicon is deformed and broken to be peeled or pulverized, so that a function as a secondary battery cannot be maintained.

Hence, in Patent Document 2, for example, a columnar or powder layer formed of microcrystalline or amorphous silicon is formed as a negative electrode active material layer over a current collector formed of copper foil or the like with a rough surface, and a layer formed of a carbon material such as graphite having lower electric conductivity than silicon is formed over the layer formed of silicon. This makes it possible to collect current through the layer formed of a carbon material such as graphite even if the layer formed of silicon is separated; thus, deterioration of battery characteristics is reduced.

### REFERENCE

[Patent Document 1] United States Patent Application Publication No. 2009/0087723
[Patent Document 2] Japanese Published Patent Application No. 2001-283834

### SUMMARY OF THE INVENTION

In the case of providing a heating circuit inside a secondary battery to fully utilize the battery performance of the secondary battery in a low temperature environment as described in Patent Document 1, however, a structure of a battery element and a structure of an extracting electrode increase in complexity. Further, a manufacturing process of the secondary battery becomes complicated. Furthermore, a special control means needs to be provided outside the secondary battery to control the heating circuit, which results in an increase in cost.

When silicon having a columnar shape or a powder form is used as a negative electrode active material layer described in Patent Document 2 to increase the capacity of the secondary battery, since carrier ions are inserted into and extracted from the negative electrode active material, the volume inevitably expands and contracts in charge and discharge repeated ten times or more as described in the document. For this reason, the negative electrode active material layer cannot be prevented from being deformed and broken. In Patent Document 2, current is collected in the layer formed of graphite on the assumption that silicon which is an active material is separated from the current collector. Thus, with this structure, reliability as a battery is difficult to maintain. In addition, description is not given of whether a secondary battery with this structure works properly or not in a low temperature environment.

In view of the above problems, an object of one embodiment of the present invention is to provide a secondary battery which can achieve battery performance satisfactorily in a low temperature environment in cold climates or the like.

Further, another object of one embodiment of the present invention is to provide a secondary battery having high capacity even in a low temperature environment in a cold climate or the like.

Note that the descriptions of these problems do not disturb the existence of other problems. Note that in one embodiment of the present invention, there is no need to achieve all the objects. Other objects will be apparent from and can be derived from the description of the specification, the drawings, the claims, and the like.

In view of the above objects, in one embodiment of the present invention, a particulate alloy-based material is used as a negative electrode active material to provide a higher capacity secondary battery.

The alloy-based material refers to an active material which can be alloyed and dealloyed with carrier ions such as lithium ions. As the alloy-based material, for example, a material containing at least one of Mg, Ca, Al, Si, Ge, Sn, Pb, As, Sb, Bi, Ag, Au, Zn, Cd, and Hg can be used. In particular, silicon (Si) having high theoretical capacity is preferably used.

Further, in one embodiment of the present invention, a negative electrode of a secondary battery includes a negative electrode current collector and a negative electrode active material layer which contains the above-described particulate alloy-based material, graphene, and a binder and which is provided over the negative electrode current collector.

Graphene serves as a conductive additive forming an electron conducting path between an active material and a current collector. Graphene in this specification includes single-layer graphene and multilayer graphene including two to hundred layers. Single-layer graphene refers to a sheet of one atomic layer of carbon molecules having π bonds. In the case of forming this graphene by reducing graphene oxide, oxygen contained in graphene oxide is not extracted entirely and remains partly in graphene. When graphene contains oxygen, the proportion of oxygen is higher than or equal to 2 at. % and lower than or equal to 20 at. %, preferably higher than or equal to 3 at. % and lower than or equal to 15 at. %. Note that graphene oxide refers to a compound formed by oxidizing such graphene.

Examples of the binder include polyimide, polytetrafluoroethylene, polyvinyl chloride, an ethylene-propylene-diene polymer, butadiene rubber, styrene-butadiene rubber, butyl rubber, acrylonitrile-butadiene rubber, fluorine rubber, polyvinyl acetate, polymethyl methacrylate, polyethylene, polypropylene, nitrocellulose, and the like, in addition to polyvinylidene fluoride (PVDF) which is a typical example. In one embodiment of the present invention, in particular, when silicon or the like whose volume changes markedly due to charge and discharge is used as the alloy-based material serving as the negative electrode active material, the use of polyimide with a high binding property enhances adhesion between particles of the particulate alloy-based material, the particulate alloy-based material and graphene, the particulate alloy-based material and the current collector, and graphene and the current collector. Thus, separation and pulverization of the alloy-based material are suppressed, which makes it possible to obtain excellent charge-discharge cycle performance.

With the use of the negative electrode active material layer containing the particulate alloy-based material, graphene, and the binder as described above, a sheet of graphene and particles of the alloy-based material have a surface contact so that the sheet surrounds the particles, and sheets of graphene also have surface contact to overlap with each other; thus, an extensive network of three-dimensional electron conducting paths is established in the negative electrode active material layer. For this reason, it is possible to form a negative electrode active material layer with higher electron conductivity than a negative electrode active material layer containing acetylene black (AB) particles or ketjen black (KB) particles which are conventionally used as a conductive additive and have an electrical point contact with a negative electrode active material.

The present inventor has found that when an electrolyte solution containing propylene carbonate (PC) as a nonaqueous solvent and lithium perchlorate (LiClO₄) as an electrolyte is used as an electrolyte solution in a secondary battery including a negative electrode in which such graphene is used as a conductive additive, excellent battery performance can be obtained even in a low temperature environment.

In particular, it has been found that high discharge capacity can be obtained even in the case of performing only constant current (CC) charge and discharge without performing constant current-constant voltage (CC-CV) charge and discharge at the time of charging and discharging the secondary battery in the low temperature environment.

That is to say, one embodiment of the present invention is a secondary battery including a positive electrode, a negative electrode, and an electrolyte solution which contains a nonaqueous solvent and an electrolyte. The negative electrode includes a negative electrode active material layer. The negative electrode active material layer contains graphene, a binder, and a negative electrode active material containing a particulate alloy-based material. The nonaqueous solvent contains propylene carbonate and the electrolyte contains lithium perchlorate.

A secondary battery which can achieve battery performance satisfactorily in a low temperature environment in cold climates or the like can be provided.

A secondary battery having high capacity even in a low temperature environment in cold climates or the like can be provided.

### BRIEF DESCRIPTION OF THE DRAWINGS

FIGS. 1A to 1D illustrate a negative electrode.

FIGS. 2A and 2B illustrate a coin-type secondary battery and a laminated secondary battery.

FIGS. 3A and 3B illustrate a cylindrical secondary battery.

FIG. 4 illustrates electronic devices.

FIGS. 5A to 5C illustrate an electronic device.

FIGS. 6A and 6B illustrate an electronic device.

FIG. 7 is a graph showing charge and discharge characteristics obtained by performing CC charge and discharge.

FIG. 8 is a graph showing charge and discharge characteristics obtained by performing CC-CV charge and discharge.

FIG. 9 is a graph showing charge and discharge characteristics at room temperature and high temperature.

FIG. 10 is a graph showing charge and discharge characteristics.

FIG. 11 is a graph showing charge and discharge characteristics of a battery with a full cell structure.

### DETAILED DESCRIPTION OF THE INVENTION

Embodiments and examples are described below with reference to drawings. However, the embodiments and the examples can be implemented with various modes. It will be readily appreciated by those skilled in the art that modes and details can be changed in various ways without departing from the spirit and scope of the present invention. Thus, the present invention should not be interpreted as being limited to the following description of the embodiments and the examples.

### Embodiment 1

In this embodiment, a negative electrode and an electrolyte and solvent of an electrolyte solution, which are used in a secondary battery of one embodiment of the present invention, are described. Further, a method for fabricating a negative electrode is described.

### (Structure of Negative Electrode)

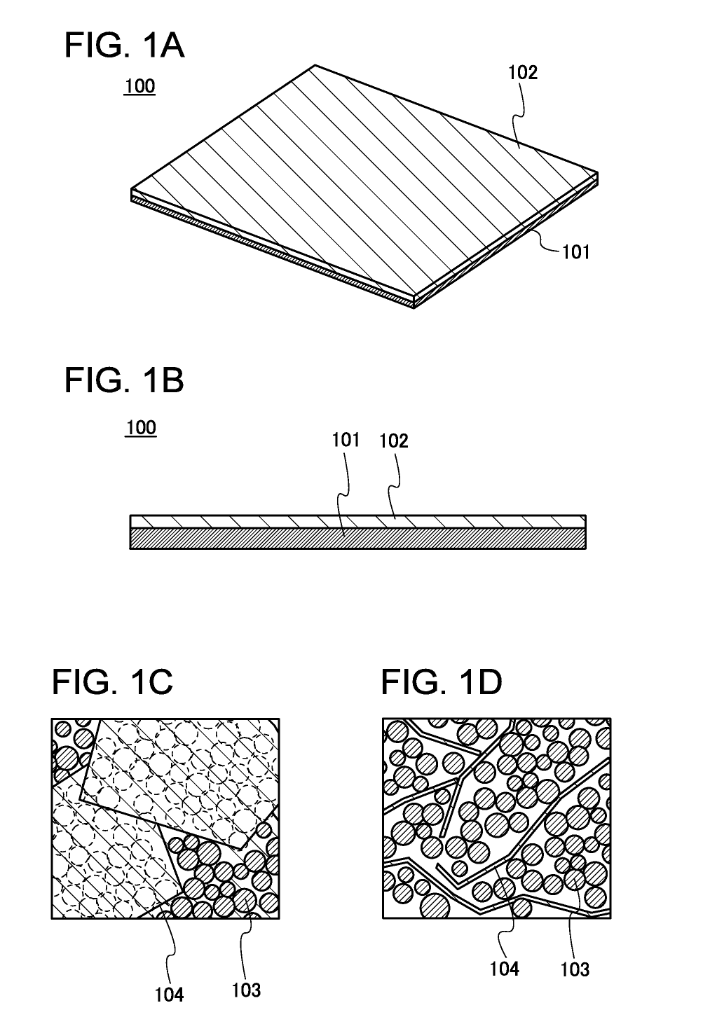

FIG. 1A is a bird's eye view of the negative electrode, and FIG. 1B is a cross-sectional view of the negative electrode in the thickness direction. A negative electrode 100 has a structure in which a negative electrode active material layer 102 is provided over a negative electrode current collector 101. Note that although the negative electrode active material layer 102 is provided on one surface of the negative electrode current collector 101 in FIGS. 1A and 1B, the negative electrode active material layer 102 may be formed on both surfaces of the negative electrode current collector 101.

The negative electrode current collector 101 can be formed using a material, which has high conductivity and is not alloyed with carrier ions such as lithium ions, e.g., a metal typified by stainless steel, gold, platinum, zinc, iron, copper, aluminum, or titanium, or an alloy thereof. Further, the negative electrode current collector 101 can be formed using an aluminum alloy to which an element which improves heat resistance, such as silicon, titanium, neodymium, scandium, or molybdenum, is added. Furthermore, the negative electrode current collector 101 may be formed using a metal element which forms silicide by reacting with silicon. Examples of the metal element which forms silicide by reacting with silicon include zirconium, titanium, hafnium, vanadium, niobium, tantalum, chromium, molybdenum, tungsten, cobalt, nickel, and the like. The negative electrode current collector 101 can have a foil-like shape, a plate-like shape (sheet-like shape), a net-like shape, a cylindrical shape, a coil shape, a punching-metal shape, an expanded-metal shape, or the like, as appropriate. The negative electrode current collector 101 preferably has a thickness of more than or equal to 10 μm and less than or equal to 30 μm.

FIG. 1C is a top view of the negative electrode active material layer 102 including a negative electrode active material 103, a sheet of graphene 104 which covers a plurality of particles of the negative electrode active material 103, and a binder (not illustrated). The different sheets of the graphene 104 cover surfaces of the particles of the negative electrode active material 103. Note that the particles of the negative electrode active material 103 may partly be exposed.

Although sufficient characteristics can be obtained even when the surface of the negative electrode active material 103 is not covered with the graphene 104, the negative electrode active material 103 is preferably covered with the graphene 104 sufficiently, in which case hopping of carrier ions occurs between the particles of the negative electrode active material 103, so that current flows easily.

Here, graphene serves as a conductive additive forming an electron conducting path between an active material and a current collector. Graphene in this specification includes single-layer graphene and multilayer graphene including two to hundred layers. The single-layer graphene refers to a sheet of one atomic layer of carbon molecules having π bonds. In the case of forming this graphene by reducing graphene oxide, oxygen contained in graphene oxide is not extracted entirely and remains partly in graphene. When graphene contains oxygen, the proportion of oxygen is higher than or equal to 2 at. % and lower than or equal to 20 at. %, preferably higher than or equal to 3 at. % and lower than or equal to 15 at. %. Note that graphene oxide refers to a compound formed by oxidizing such graphene.

As described above, the negative electrode active material layer 102 includes graphene as the conductive additive to improve the characteristics of an electron conducting path in the negative electrode active material layer 102, and in addition to graphene, the negative electrode active material layer 102 may include various conductive additives, for example, carbon particles such as acetylene black particles, ketjen black particles, and carbon nanofibers.

For the negative electrode active material 103, a metal which is alloyed and dealloyed with carrier ions to enable charge/discharge reaction to occur can be used. Examples of the metal include Mg, Ca, Al, Si, Ge, Sn, Pb, As, Sb, Bi, Ag, Au, Zn, Cd, Hg, and the like. Such a metal has higher capacity than graphite. In particular, silicon (Si) has a significantly high theoretical capacity of 4200 mAh/g. For this reason, silicon is preferably used as the negative electrode active material 103. Examples of an alloy-based material using the above elements include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, as the negative electrode active material, an oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), molybdenum oxide (MoO₂), or the like can be used.

Further alternatively, as the negative electrode active material, Li₃₋ₓMₓN (M=Co, Ni, or Cu) with a Li₃N structure, which is nitride containing lithium and a transition metal, can be used. For example, Li_{2.6}Co_{0.4}N₃ is preferable because of its high charge and discharge capacity (900 mAh/g).

The nitride containing lithium and a transition metal is preferably used, in which case lithium ions are included in the negative electrode active material, and thus the negative electrode active material can be used in combination with a material for a positive electrode active material which does not include lithium ions, such as V₂O₅ or Cr₃O₈. Note that in the case of using a material containing lithium ions for a positive electrode active material, the nitride containing lithium and a transition metal can be used for the negative electrode active material by extracting lithium ions included in the positive electrode active material in advance.

In the case of using silicon as the negative electrode active material, amorphous silicon, microcrystalline silicon, polycrystalline silicon, or a combination thereof can be used. In general, silicon with higher crystallinity has higher electric conductivity; thus, silicon can be used as an electrode having high conductivity in a power storage device. On the other hand, amorphous silicon can occlude more carrier ions such as lithium ions than crystalline silicon, which results in an increase in discharge capacity.

Examples of the binder which is not illustrated include polyimide, polytetrafluoroethylene, polyvinyl chloride, an ethylene-propylene-diene polymer, butadiene rubber, styrene-butadiene rubber, butyl rubber, acrylonitrile-butadiene rubber, fluorine rubber, polyvinyl acetate, polymethyl methacrylate, polyethylene, polypropylene, nitrocellulose, and the like, in addition to polyvinylidene fluoride (PVDF) which is a typical example. In particular, when silicon or the like whose volume changed markedly due to charge and discharge is used as the negative electrode active material 103, the use of polyimide with a high binding property enhance adhesion between particles of the negative electrode active material, the negative electrode active material and graphene, the negative electrode active material and the current collector, and graphene and the current collector. Thus, separation and pulverization of the negative electrode active material are suppressed, which makes it possible to obtain excellent charge-discharge cycle performance.

FIG. 1D is a cross-sectional view of part of the negative electrode active material layer 102 in FIG. 1C. The negative electrode active material layer 102 includes the negative electrode active material 103 and sheets of the graphene 104 each covering part of the negative electrode active material 103. The sheets of the graphene 104 are observed to have linear shapes in the cross-sectional view. Part of the particles of the negative electrode active material 103 are at least partly surrounded with one sheet of graphene or plural sheets of graphene. That is, part of the particles of the negative electrode active material 103 exist within one sheet of graphene or plural sheets of graphene. Note that the sheet of graphene has a bag-like shape and part of the particles of the negative electrode active material 103 is at least partly surrounded with the bag-like portion. In addition, the particles of the negative electrode active material 103 are partly not covered with the sheets of the graphene 104 and exposed in some cases.

In addition to having a function as a conductive additive, the graphene 104 has a function of holding the negative electrode active material 103 that can occlude and release carrier ions. For this reason, the proportion of the negative electrode active material in the negative electrode active material layer 102 can be increased, resulting in an increase in the discharge capacity of a lithium secondary battery.

Further, in the negative electrode active material 103 whose volume is increased due to occlusion of carrier ions, the negative electrode active material layer 102 gets friable due to charge and discharge, and thus the negative electrode active material layer 102 might be partly broken. The negative electrode active material layer 102 which is partly broken decreases the reliability of a secondary battery. However, even when the volume of the negative electrode active material 103 is increased due to charge and discharge, the graphene 104 cover the periphery of the negative electrode active material 103, which allows prevention of dispersion of the particles of the negative electrode active material 103 and the break of the negative electrode active material layer 102. In other words, the graphene 104 has a function of keeping the bond between the particles of the negative electrode active material 103 even when the volume of the particles of the negative electrode active material 103 is increased and decreased due to charge and discharge.

### (Electrolyte)

As the electrolyte contained in the electrolyte solution, a material containing carrier ions is used. In particular, LiClO₄ is preferably used in one embodiment of the present invention. LiClO₄ may be used alone or an appropriate combination of LiClO₄ and one or more of other electrolytes in an appropriate ratio may be used.

One or more of lithium salts such as LiPF₆, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used in an appropriate combination with LiClO₄ in an appropriate ratio.

### (Solvent)

As the solvent of the electrolyte solution, a material in which carrier ions can transfer is used. It is preferable that propylene carbonate (PC) be particularly used in one embodiment of the present invention. Propylene carbonate may be used alone or an appropriate combination of propylene carbonate and one or more of other solvents in an appropriate ratio may be used.

One or more of ethylene carbonate (EC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane, dimethyl sulfoxide, diethyl ether, methyl diglyme, acetonitrile, benzonitrile, tetrahydrofuran, sulfolane, and sultone can be used in an appropriate combination with propylene carbonate in an appropriate ratio.

The above-described negative electrode and the above-described electrolyte and solvent of the electrolyte solution can be used in the secondary battery which is one embodiment of the present invention.

When an electrolyte solution containing propylene carbonate (PC) as a nonaqueous solvent and lithium perchlorate (LiClO₄) as an electrolyte is used as an electrolyte solution in a secondary battery including a negative electrode in which graphene is used as a conductive additive, excellent battery performance can be obtained even in a low temperature environment.

### (Method for Fabricating Negative Electrode)

The negative electrode active material layer 102 in the negative electrode 100 of one embodiment of the present invention includes the graphene 104 as described above. Graphene can be obtained, for example, by mixing graphene oxide that is a raw material of graphene, a negative electrode active material, and a binder and then thermally reducing the mixture. An example of a method for fabricating a negative electrode including such graphene is described below.

First, graphene oxide that is the raw material of graphene is formed. Graphene oxide can be formed by various synthesis methods such as a Hummers method, a modified Hummers method, and oxidation of graphite.

For example, the Hummers method is a method for forming graphite oxide by oxidizing graphite such as flake graphite. The formed graphite oxide is graphite which is oxidized in places, and thus a functional group such as a carbonyl group, a carboxyl group, or a hydroxyl group is bonded thereto. The crystallinity of the graphite is decreased, and the distance between layers of the graphite is increased. Therefore, the layers can be easily separated by ultrasonic treatment or the like to obtain graphene oxide. The length of one side (also referred to as a flake size) of graphene oxide which is formed is preferably several micrometers to several tens of micrometers.

Next, graphene oxide obtained by the above-described method or the like, the particulate negative electrode active material, and the binder are added to and mixed with a solvent. The mixture ratio thereof is adjusted appropriately depending on the desired battery performance. For example, the ratio of the particulate negative electrode active material to graphene oxide and the binder can be 40:40:20 (weight percent).

As the solvent, a liquid in which a raw material is not dissolved but dispersed can be used. Further, the solvent is preferably a polar solvent. For example, one of water, methanol, ethanol, acetone, tetrahydrofuran (THF), dimethylformamide (DMF), N-methyl-2-pyrrolidone (NMP), and dimethyl sulfoxide (DMSO) or a mixed solution of two or more of the polar solvents can be used.

As the binder, a binder with high heat resistance, such as polyimide, is used. Note that a substance mixed in the mixing step is a precursor of polyimide, and the precursor of polyimide is imidized in a heating step performed later to be polyimide.

Here, there is no particular limitation on the sequence of adding graphene oxide, the particulate negative electrode active material, and the binder to the solvent. For example, the particulate negative electrode active material is added to and mixed with the solvent, graphene oxide is added thereto and mixed therewith, and then the binder is added thereto and mixed therewith. To adjust the viscosity of the mixture, the solvent may be additionally added in each of the mixing steps.

Note that graphene oxides are not easily aggregated in a solution having polarity because graphene oxides are negatively charged due to functional groups included in graphene oxides. Thus, graphene oxides are likely to disperse uniformly in the solution having polarity. Being added to and mixed with the solvent in the initial step of the mixing steps, graphene oxides are more likely to disperse uniformly in the solvent. Consequently, graphene is dispersed uniformly in the negative electrode active material, which enables the negative electrode active material with high electric conductivity to be formed.

As a method for mixing the above compounds, for example, ball mill treatment can be used. Specifically, the above compounds are weighed and added to the solvent, the mixture is put into a container together with metallic balls or ceramic balls, and the container is rotated, for example. With the ball mill treatment, the compounds can be mixed and formed into minute particles, so that the obtained electrode material can be minute particles. Further, with the ball mill treatment, the compounds that are raw materials can be mixed uniformly.

Through the above steps, the particulate negative electrode active material, graphene oxide, the binder, and the solvent are mixed to form slurry (mixture).

Next, the slurry is applied to the negative electrode current collector 101, and the negative electrode current collector to which the slurry is applied is dried to remove the solvent. The drying step is performed at room temperature in a dry atmosphere, for example. Note that in the case where the solvent can be removed in the heating step performed later, the drying step is not necessarily performed.

Next, the negative electrode current collector to which the slurry is applied is heated. The heating temperature is higher than or equal to 200° C. and lower than or equal to 400° C., preferably approximately 300° C. The heating temperature is kept for more than or equal to 1 hour and less than or equal to 2 hours, preferably approximately 1 hour. Through the heating step, the slurry is baked and thus the precursor of polyimide is imidized to be polyimide. At the same time, graphene oxide is reduced to form graphene. Heating for baking the slurry and heating for reducing graphene oxide can be performed through one heating step as described above; thus, there is no need for performing two heating steps. Consequently, the number of steps for fabricating the negative electrode can be reduced.

In this embodiment, the heating step of baking the slurry and reducing graphene oxide is performed at a temperature at which the binder is not decomposed, for example, higher than or equal to 200° C. and lower than or equal to 400° C., preferably 300° C. This makes it possible to prevent decomposition of the binder and a decrease in the reliability of the secondary battery.

In addition, the reduced graphene oxide (i.e., graphene) has low dispersibility as described above. In the case of using graphene oxide which is reduced before being mixed with an active material and a binder, graphene is not uniformly mixed with the active material and the like; consequently, a secondary battery might have poor electrical characteristics. This results from the fact that graphene oxides are negatively charged due to the bond of functional groups containing oxygen and surfaces of graphene oxides and thus are dispersed by occurrence of the repulsion between graphene oxides or the repulsion between graphene oxides and a polar solvent, whereas graphene which is reduced graphene oxide lose many of functional groups due to the reduction and have low dispersibility accordingly.

In the negative electrode active material layer formed by mixing graphene oxide and an active material and then heating the mixture, graphene is uniformly dispersed in the negative electrode active material layer because graphene oxide is dispersed before functional groups are reduced due to the reduction. For this reason, a secondary battery with high electric conductivity can be obtained by performing reduction treatment after graphene oxide is dispersed.

Through the above-described fabrication steps, the negative electrode 100 in which the negative electrode active material layer 102 is provided over the negative electrode current collector 101 can be fabricated.

This embodiment can be implemented combining with other embodiments as appropriate.

### Embodiment 2

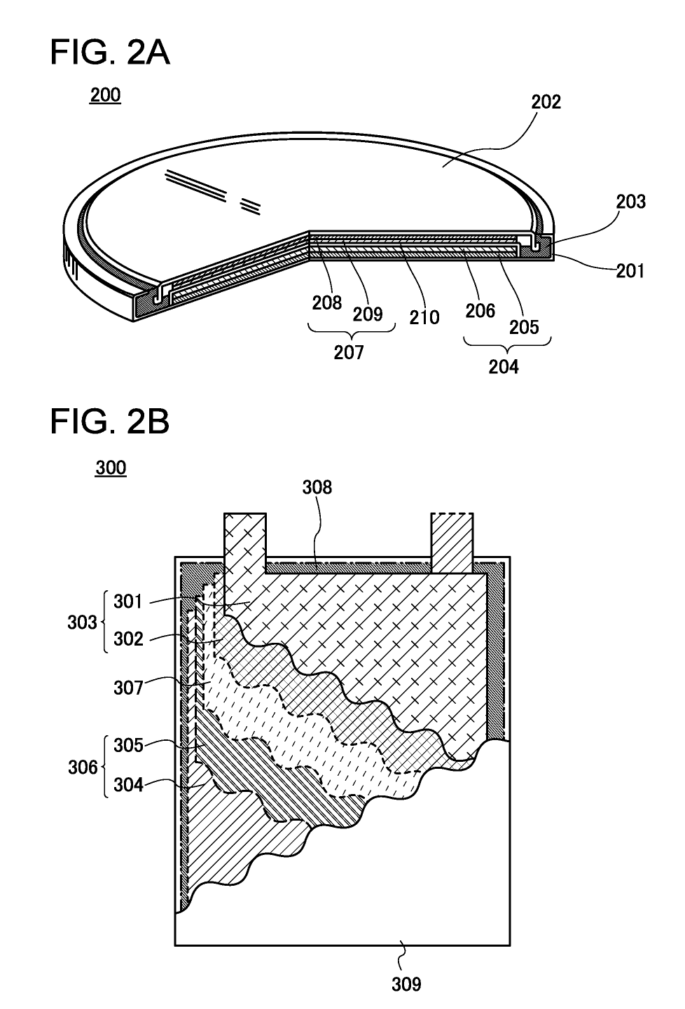

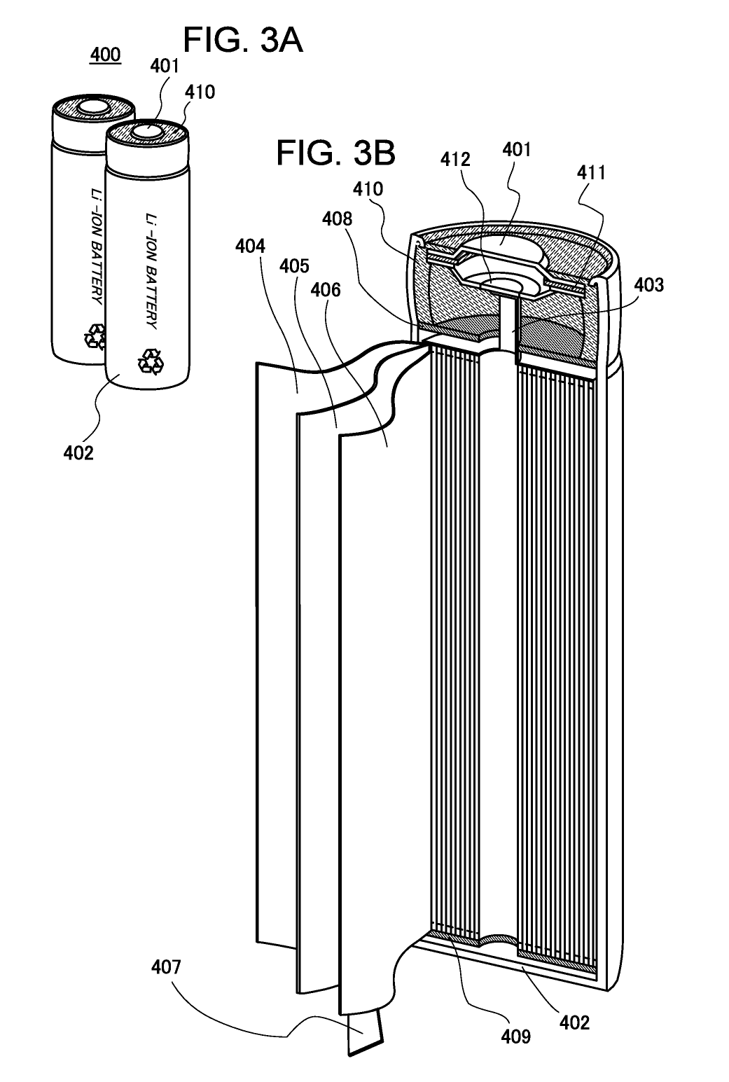

In this embodiment, structures of a secondary battery are described with reference to FIGS. 2A and 2B and FIGS. 3A and 3B.

### (Coin-Type Secondary Battery)

FIG. 2A is an external view of a coin-type (single-layer flat type) secondary battery, part of which also illustrates a cross-sectional view of part of the coin-type secondary battery.

In a coin-type secondary battery 200, a positive electrode can 201 serving also as a positive electrode terminal and a negative electrode can 202 serving also as a negative electrode terminal are insulated and sealed with a gasket 203 formed of polypropylene or the like. A positive electrode 204 includes a positive electrode current collector 205 and a positive electrode active material layer 206 which is provided to be in contact with the positive electrode current collector 205. A negative electrode 207 is formed of a negative electrode current collector 208 and a negative electrode active material layer 209 which is provided to be in contact with the negative electrode current collector 208. A separator 210 and an electrolyte (not illustrated) are included between the positive electrode active material layer 206 and the negative electrode active material layer 209.

As the negative electrode 207, the negative electrode 100 which is described in Embodiment 1 and in which graphene is used as the conductive additive is used.

As the positive electrode 204, any of a variety of known positive electrodes can be used. For example, the positive electrode 204 may include the positive electrode current collector 205 and the positive electrode active material layer 206 provided thereover.

The positive electrode current collector 205 can be formed using a material having high conductivity such as a metal typified by stainless steel, gold, platinum, zinc, iron, copper, aluminum, or titanium, or an alloy thereof. Further, the positive electrode current collector 205 can be formed using an aluminum alloy to which an element which improves heat resistance, such as silicon, titanium, neodymium, scandium, or molybdenum, is added. Furthermore, the positive electrode current collector 205 may be formed using a metal element which forms silicide by reacting with silicon. Examples of the metal element which forms silicide by reacting with silicon include zirconium, titanium, hafnium, vanadium, niobium, tantalum, chromium, molybdenum, tungsten, cobalt, nickel, and the like. The positive electrode current collector 205 can have a foil-like shape, a plate-like shape (a sheet-like shape), a net-like shape, a punching-metal shape, an expanded-metal shape, or the like as appropriate.

As a positive electrode active material used for the positive electrode active material layer, a material into/from which lithium ions can be inserted and extracted can be used. For example, a lithium-containing composite oxide with an olivine crystal structure, a layered rock-salt crystal structure, or a spinel crystal structure can be given.

As the lithium-containing composite oxide with an olivine crystal structure, a composite oxide represented by a general formula LiMPO₄ (M is one or more of Fe(II), Mn(II), Co(II), and Ni(II)) can be given. Typical examples of the general formula LiMPO₄ include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), LiFe_{f}Ni_{g}CoₕMnᵢPO₄ (f+g+h+i≦1, 0<f<1, 0<g<1, 0<h<1, and 0<i<1), and the like.

LiFePO₄ is particularly preferable because it meets requirements with balance for a positive electrode active material, such as safety, stability, high capacity density, high potential, and the existence of lithium ions that can be extracted in initial oxidation (charging).

Examples of the lithium-containing composite oxide with a layered rock-salt crystal structure include lithium cobalt oxide (LiCoO₂); LiNiO₂; LiMnO₂; Li₂MnO₃; an NiCo-based lithium-containing composite oxide (a general formula thereof is LiNiₓCo₁₋ₓO₂ (0<x<1)) such as LiNi_{0.8}Co_{0.2}O₂; an NiMn-based lithium-containing composite oxide (a general formula thereof is LiNiₓMn₁₋ₓO₂ (0<x<1)) such as LiNi_{0.5}Mn_{0.5}O₂; and an NiMnCo-based lithium-containing composite oxide (also referred to as NMC, and a general formula thereof is LiNiₓMn_{y}Co_{1-x-y}O₂ (x>0, y>0, x+y<1)) such as LiNi_{1/3}Mn_{1/3}Co_{1/3}O₂. Moreover, Li(Ni_{0.8}Co_{0.15}Al_{0.05})O₂, Li₂MnO₃—LiMO₂ (M=Co, Ni, or Mn), and the like can be given.

LiCoO₂ is particularly preferable because it has high capacity, is more stable in the air than LiNiO₂, and is more thermally stable than LiNiO₂, for example.

Examples of the lithium-containing composite oxide with a spinel crystal structure include LiMn₂O₄, Li₁₊ₓMn₂₋ₓO₄, Li(MnAl)₂O₄, LiMn_{1.5}Ni_{0.5}O₄, and the like.

A lithium-containing composite oxide with a spinel crystal structure including manganese, such as LiMn₂O₄, is preferably mixed with a small amount of lithium nickel oxide (e.g., LiNiO₂ or LiNi₁₋ₓMO₂ (M=Co, Al, or the like)), in which case elution of manganese is suppressed, for example.

As the positive electrode active material, a composite oxide represented by a general formula Li(₂₋ⱼ)MSiO₄ (M is one or more of Fe(II), Mn(II), Co(II), and Ni(II); 0≦j≦2) can be used. Typical examples of the general formula Li(₂₋ⱼ)MSiO₄ include Li(₂₋ⱼ)FeSiO₄, Li(₂₋ⱼ)NiSiO₄, Li(₂₋ⱼ)CoSiO₄, Li(₂₋ⱼ)MnSiO₄, Li(₂₋ⱼ)FeₖNiₗSiO₄, Li(₂₋ⱼ)FeₖCoₗSiO₄, Li(₂₋ⱼ)FeₖMnₗSiO₄, Li(₂₋ⱼ)NiₖCoₗSiO₄, Li(₂₋ⱼ)NiₖMnₗSiO₄ (k+l≦1, 0<k<1, and 0<l<1), Li(₂₋ⱼ)FeₘNiₙCo_{q}SiO₄, Li(₂₋ⱼ)FeₘNiₙMn_{q}SiO₄, Li(₂₋ⱼ)NiₘCoₙMn_{q}SiO₄ (m+n+q≦1, 0<m<1, 0<n<1, and 0<q<1), Li(₂₋ⱼ)FeᵣNiₛCoₜMnᵤSiO₄ (r+s+t+u≦1, 0<r<1, 0<s<1, 0<t<1, and 0<u<1), and the like.

Further, as the positive electrode active material, a nasicon compound represented by a general formula AₓM₂(XO₄)₃ (A=Li, Na, or Mg; M=Fe, Mn, Ti, V, Nb, or Al; and X=S, P, Mo, W, As, or Si) can be used. Examples of the nasicon compound include Fe₂(MnO₄)₃, Fe₂(SO₄)₃, Li₃Fe₂(PO₄)₃, and the like. Furthermore, as the positive electrode active material, a compound represented by a general formula Li₂MPO₄F, Li₂MP₂O₇, or Li₅MO₄ (M=Fe or Mn); perovskite fluoride such as NaF₃ or FeF₃; metal chalcogenide such as TiS₂ or MoS₂ (sulfide, selenide, or telluride); a lithium-containing composite oxide with an inverse spinel crystal structure such as LiMVO₄; a vanadium oxide based material (e.g., V₂O₅, V₆O₁₃, and LiV₃O₈); a manganese oxide based material; an organic sulfur based material; or the like can be used.

In the case where carrier ions are alkali metal ions other than lithium ions, alkaline-earth metal ions, beryllium ions, or magnesium ions, the positive electrode active material layer 206 may contain, instead of lithium in the lithium compound and the lithium-containing composite oxide, an alkali metal (e.g., sodium or potassium), an alkaline-earth metal (e.g., calcium, strontium, or barium), beryllium, or magnesium.

The positive electrode active material layer 206 is formed over the positive electrode current collector 205 by a coating method or a physical vapor deposition method (e.g., a sputtering method), whereby the positive electrode 204 can be formed. In the case of using the coating method, the positive electrode active material layer 206 is formed in such a manner that a paste in which a conductive additive (e.g., acetylene black (AB)), a binder (e.g., polyvinylidene fluoride (PVDF)), and the like are mixed with any of the above materials for the positive electrode active material layer 206 is applied to the positive electrode current collector 205 and dried. In this case, the positive electrode active material layer 206 is preferably molded by applying pressure as needed.

Note that as the conductive additive, an electron-conductive material can be used as long as it does not chemically change in the secondary battery. For example, a carbon-based material such as graphite or carbon fiber; a metal material such as copper, nickel, aluminum, or silver; and powder, fiber, and the like of mixtures thereof can be used. Further, graphene may be used instead of these conductive additives. For example, a polar solvent to which a positive electrode active material, a binder, and graphene oxide are added is mixed, and the mixture is subjected to heat treatment or the like to reduce graphene oxide; thus, a positive electrode active material layer containing graphene can be formed. An electron conducting path connecting particles of the positive electrode active material is formed in the positive electrode active material layer including graphene in such a manner; thus, the positive electrode active material layer can have high electron conductivity, which is similar to the negative electrode of one embodiment of the present invention.

As the binder, instead of polyvinylidene fluoride (PVDF) as a typical one, polyimide, polytetrafluoroethylene, polyvinyl chloride, ethylene-propylene-diene polymer, butadiene rubber, styrene-butadiene rubber, butyl rubber, acrylonitrile-butadiene rubber, fluorine rubber, polyvinyl acetate, polymethyl methacrylate, polyethylene, polypropylene, nitrocellulose or the like can be used.

The positive electrode active material layer 206 is not necessarily in direct contact with a surface of the positive electrode current collector 205. Between the positive electrode current collector 205 and the positive electrode active material layer 206, any of the following functional layers may be formed using a conductive material such as a metal: an adhesive layer for the purpose of improving adhesiveness between the positive electrode current collector 205 and the positive electrode active material layer 206, a planarization layer for reducing unevenness of the surface of the positive electrode current collector 205, a heat radiation layer for radiating heat, and a stress relaxation layer for reducing stress on the positive electrode current collector 205 or the positive electrode active material layer 206. Further, to have these functions, treatment for modifying a state of a surface may be performed on the surface of the positive electrode current collector 205.

Next, as the separator 210, a porous insulator such as cellulose (paper), polypropylene (PP), polyethylene (PE), polybutene, nylon, polyester, polysulfone, polyacrylonitrile, polyvinylidene fluoride, or tetrafluoroethylene can be used. Further, nonwoven fabric of a glass fiber or the like, or a diaphragm in which a glass fiber and a high molecular fiber are combined may be used.

As the electrolyte contained in an electrolyte solution, the electrolyte described in Embodiment 1 can be used.

As a solvent of the electrolyte solution, the solvent described in Embodiment 1 can be used.

For the positive electrode can 201 and the negative electrode can 202, a metal having a corrosion-resistant property to a liquid such as an electrolytic solution in charging and discharging a secondary battery, such as nickel, aluminum, or titanium; an alloy of any of the metals; an alloy containing any of the metals and another metal (e.g., stainless steel); a stack of any of the metals; a stack including any of the metals and any of the alloys (e.g., a stack of stainless steel and aluminum); or a stack including any of the metals and another metal (e.g., a stack of nickel, iron, and nickel) can be used. The positive electrode can 201 and the negative electrode can 202 are electrically connected to the positive electrode 204 and the negative electrode 207, respectively.

The negative electrode 207, the positive electrode 204, and the separator 210 are immersed in the electrolyte solution. Then, as illustrated in FIG. 2A, the positive electrode can 201, the positive electrode 204, the separator 210, the negative electrode 207, and the negative electrode can 202 are stacked in this order with the positive electrode can 201 positioned at the bottom, and the positive electrode can 201 and the negative electrode can 202 are subjected to pressure bonding with the gasket 203 interposed therebetween. In such a manner, the coin-type secondary battery 200 is manufactured.

### (Laminated Secondary Battery)

Next, an example of a laminated secondary battery is described with reference to FIG. 2B.

A laminated secondary battery 300 illustrated in FIG. 2B includes a positive electrode 303 including a positive electrode current collector 301 and a positive electrode active material layer 302, a negative electrode 306 including a negative electrode current collector 304 and a negative electrode active material layer 305, a separator 307, an electrolyte solution 308, and an exterior body 309. The separator 307 is placed between the positive electrode 303 and the negative electrode 306 provided in the exterior body 309. The exterior body 309 is filled with the electrolyte solution 308.

As the negative electrode 306, the negative electrode 100 which is described in Embodiment 1 and in which graphene is used as the conductive additive is used.

Further, in one embodiment of the present invention, the electrolyte and solvent described in Embodiment 1 can be used for the electrolyte solution 308 as in the above-described coin-type secondary battery.

In the laminated secondary battery 300 illustrated in FIG. 2B, the positive electrode current collector 301 and the negative electrode current collector 304 also serve as terminals for an electrical contact with the outside. For this reason, each of the positive electrode current collector 301 and the negative electrode current collector 304 is arranged so that part of the positive electrode current collector 301 and part of the negative electrode current collector 304 are exposed outside the exterior body 309.

As the exterior body 309 in the laminated secondary battery 300, for example, a laminate film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used. With such a three-layer structure, permeation of an electrolytic solution and a gas can be blocked and an insulating property and resistance to the electrolytic solution can be provided.

### (Cylindrical Secondary Battery)

Next, examples of a cylindrical secondary battery are described with reference to FIGS. 3A and 3B. As illustrated in FIG. 3A, a cylindrical secondary battery 400 includes a positive electrode cap (battery cap) 401 on the top surface and a battery can (outer can) 402 on the side surface and bottom surface. The positive electrode cap 401 and the battery can (exterior can) 402 are insulated from each other by a gasket (insulating gasket) 410.

FIG. 3B is a diagram schematically illustrating a cross section of the cylindrical secondary battery. Inside the battery can 402 having a hollow cylindrical shape, a battery element in which a strip-like positive electrode 404 and a strip-like negative electrode 406 are wound with a stripe-like separator 405 interposed therebetween is provided. Although not illustrated, the battery element is wound around a center pin as a center. One end of the battery can 402 is close and the other end thereof is open.

As the negative electrode 406, the negative electrode 100 which is described in Embodiment 1 and in which graphene is used as the conductive additive is used.

For the battery can 402, a metal having a corrosion-resistant property to a liquid such as an electrolytic solution in charging and discharging a secondary battery, such as nickel, aluminum, or titanium; an alloy of any of the metals; an alloy containing any of the metals and another metal (e.g., stainless steel); a stack of any of the metals; a stack including any of the metals and any of the alloys (e.g., a stack of stainless steel and aluminum); or a stack including any of the metals and another metal (e.g., a stack of nickel, iron, and nickel) can be used. Inside the battery can 402, the battery element in which the positive electrode, the negative electrode, and the separator are wound is interposed between a pair of insulating plates 408 and 409 which face each other.

Further, the battery can 402 including the battery element is filled with an electrolyte solution (not illustrated). In one embodiment of the present invention, the electrolyte and solvent described in Embodiment 1 can be used for the electrolyte solution as in the above-described coin-type secondary battery or laminated secondary battery.

Since the positive electrode 404 and the negative electrode 406 of the cylindrical secondary battery are wound, active materials are formed on both sides of the current collectors. A positive electrode terminal (positive electrode current collecting lead) 403 is connected to the positive electrode 404, and a negative electrode terminal (negative electrode current collecting lead) 407 is connected to the negative electrode 406. Both the positive electrode terminal 403 and the negative electrode terminal 407 can be formed using a metal material such as aluminum. The positive electrode terminal 403 and the negative electrode terminal 407 are resistance-welded to a safety valve mechanism 412 and the bottom of the battery can 402, respectively. The safety valve mechanism 412 is electrically connected to the positive electrode cap 401 through a positive temperature coefficient (PTC) element 411. The safety valve mechanism 412 cuts off electrical connection between the positive electrode cap 401 and the positive electrode 404 when the internal pressure of the battery increases and exceeds a predetermined threshold value. The PTC element 411 is a heat sensitive resistor whose resistance increases as temperature rises, and controls the amount of current by increase in resistance to prevent unusual heat generation. Note that barium titanate (BaTiO₃)-based semiconductor ceramic or the like can be used for the PTC element.

Note that in this embodiment, the coin-type secondary battery, the laminated secondary battery, and the cylindrical secondary battery are given as examples of the secondary battery; however, any of secondary batteries with the other various shapes, such as a sealed storage battery and a square storage battery, can be used. Further, a structure in which a plurality of positive electrodes, a plurality of negative electrodes, and a plurality of separators are stacked or rolled may be employed.

This embodiment can be implemented combining with other embodiments as appropriate.

### Embodiment 3

The secondary battery of one embodiment of the present invention can be used as a power supply for a variety of electronic devices which can operate with electric power. In particular, the secondary battery of one embodiment of the present invention is suitable for electronic devices expected to be used in a low temperature environment in cold climates or the like.

Specific examples of electronic devices each using the secondary battery of one embodiment of the present invention are as follows: display devices of televisions, monitors, and the like, lighting devices, desktop personal computers and laptop personal computers, word processors, image reproduction devices which reproduce still images and moving images stored in recording media such as digital versatile discs (DVDs), portable CD players, portable radios, tape recorders, headphone stereos, stereos, table clocks, wall clocks, cordless phone handsets, transceivers, portable wireless devices, mobile phones, car phones, portable game machines, calculators, portable information terminals, electronic notebooks, e-book readers, electronic translators, audio input devices, video cameras, digital still cameras, toys, electric shavers, high-frequency heating devices such as microwave ovens, electric rice cookers, electric washing machines, electric vacuum cleaners, water heaters, electric fans, hair dryers, air-conditioning systems such as air conditioners, humidifiers, and dehumidifiers, dishwashers, dish dryers, clothes dryers, futon dryers, electric refrigerators, electric freezers, electric refrigerator-freezers, freezers for preserving DNA, flashlights, electric power tools such as chain saws, smoke detectors, and medical equipment such as dialyzers. The examples also include industrial equipment such as guide lights, traffic lights, belt conveyors, elevators, escalators, industrial robots, power storage systems, and power storage devices for leveling the amount of power supply and smart grid. In addition, moving objects driven by motors using electric power from a secondary battery are also included in the category of electronic devices. Examples of the moving objects include electric vehicles (EV), hybrid electric vehicles (HEV) which include both an internal-combustion engine and a motor, plug-in hybrid electric vehicles (PHEV), tracked vehicles in which caterpillar tracks are substituted for wheels of these vehicles, motorized bicycles including motor-assisted bicycles, motorcycles, electric wheelchairs, golf carts, boats, ships, submarines, helicopters, aircrafts, rockets, artificial satellites, space probes, planetary probes, and spacecrafts.

In the above electronic devices, the secondary battery of one embodiment of the present invention can be used as a main power source for supplying enough power for almost the whole power consumption. Alternatively, in the above electronic devices, the secondary battery of one embodiment of the present invention can be used as an uninterruptible power source which can supply power to the electronic devices when the supply of power from the main power source or a commercial power source is stopped. Still alternatively, in the above electronic devices, the secondary battery of one embodiment of the present invention can be used as an auxiliary power source for supplying power to the electronic devices at the same time as the power supply from the main power source or a commercial power source.

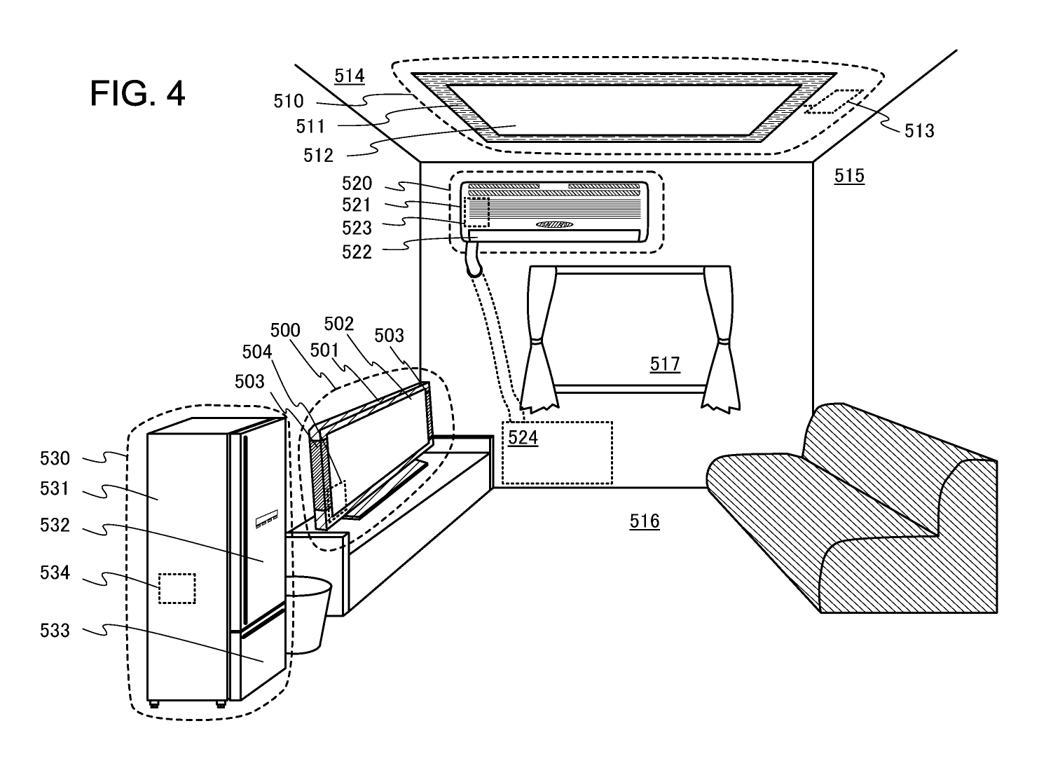

FIG. 4 illustrates specific structures of the electronic devices. In FIG. 4, a display device 500 is an example of an electronic device including a secondary battery 504 of one embodiment of the present invention. Specifically, the display device 500 corresponds to a display device for TV broadcast reception and includes a housing 501, a display portion 502, speaker portions 503, the secondary battery 504, and the like. The secondary battery 504 of one embodiment of the present invention is provided in the housing 501. The display device 500 can receive power from a commercial power source. Alternatively, the display device 500 can use power stored in the secondary battery 504. Thus, the display device 500 can be operated with the use of the secondary battery 504 of one embodiment of the present invention as an uninterruptible power source even when power cannot be supplied from a commercial power source due to power failure or the like.

A semiconductor display device such as a liquid crystal display device, a light-emitting device in which a light-emitting element such as an organic EL element is provided in each pixel, an electrophoretic display device, a digital micromirror device (DMD), a plasma display panel (PDP), or a field emission display (FED) can be used for the display portion 502.

Note that the display device includes, in its category, all of information display devices for personal computers, advertisement displays, and the like in addition to TV broadcast reception.

In FIG. 4, an installation lighting device 510 is an example of an electronic device using a secondary battery 513 of one embodiment of the present invention. Specifically, the installation lighting device 510 includes a housing 511, a light source 512, the secondary battery 513, and the like. Although FIG. 4 illustrates the case where the secondary battery 513 is provided in a ceiling 514 on which the housing 511 and the light source 512 are installed, the secondary battery 513 may be provided in the housing 511. The installation lighting device 510 can receive power from a commercial power source. Alternatively, the installation lighting device 510 can use power stored in the secondary battery 513. Thus, the installation lighting device 510 can be operated with the use of the secondary battery 513 of one embodiment of the present invention as an uninterruptible power source even when power cannot be supplied from a commercial power source due to power failure or the like.

Note that although the installation lighting device 510 provided in the ceiling 514 is illustrated in FIG. 4 as an example, the secondary battery of one embodiment of the present invention can be used as an installation lighting device provided in, for example, a wall 515, a floor 516, a window 517, or the like other than the ceiling 514. Alternatively, the secondary battery can be used in a tabletop lighting device or the like.

As the light source 512, an artificial light source which emits light artificially by using power can be used. Specifically, an incandescent lamp, a discharge lamp such as a fluorescent lamp, and a light-emitting element such as an LED and an organic EL element are given as examples of the artificial light source.

In FIG. 4, an air conditioner including an indoor unit 520 and an outdoor unit 524 is an example of an electronic device using a secondary battery 523 of one embodiment of the present invention. Specifically, the indoor unit 520 includes a housing 521, an air outlet 522, the secondary battery 523, and the like. Although FIG. 4 illustrates the case where the secondary battery 523 is provided in the indoor unit 520, the secondary battery 523 may be provided in the outdoor unit 524. Alternatively, the secondary battery 523 may be provided in both the indoor unit 520 and the outdoor unit 524. The air conditioner can receive power from a commercial power source. Alternatively, the air conditioner can use power stored in the secondary battery 523. Particularly in the case where the secondary battery 523 are provided in both the indoor unit 520 and the outdoor unit 524, the air conditioner can be operated with the use of the secondary battery 523 of one embodiment of the present invention as an uninterruptible power source even when power cannot be supplied from a commercial power source due to power failure or the like.

Note that although the split-type air conditioner including the indoor unit and the outdoor unit is illustrated in FIG. 4 as an example, the secondary battery of one embodiment of the present invention can be used in an air conditioner in which the functions of an indoor unit and an outdoor unit are integrated in one housing.

In FIG. 4, an electric refrigerator-freezer 530 is an example of an electronic device using a secondary battery 534 of one embodiment of the present invention. Specifically, the electric refrigerator-freezer 530 includes a housing 531, a door for a refrigerator 532, a door for a freezer 533, the secondary battery 534, and the like. The secondary battery 534 is provided inside the housing 531 in FIG. 4. The electric refrigerator-freezer 530 can receive power from a commercial power source. Alternatively, the electric refrigerator-freezer 530 can use power stored in the secondary battery 534. Thus, the electric refrigerator-freezer 530 can be operated with the use of the secondary battery 534 of one embodiment of the present invention as an uninterruptible power source even when power cannot be supplied from a commercial power source due to power failure or the like.

Note that among the electronic devices described above, a high-frequency heating apparatus such as a microwave oven and an electronic device such as an electric rice cooker require high power in a short time. The tripping of a circuit breaker of a commercial power source in use of electronic devices can be prevented by using the secondary battery of one embodiment of the present invention as an auxiliary power source for supplying power which cannot be supplied enough by a commercial power source.

In addition, in a time period when electronic devices are not used, particularly when the proportion of the amount of power which is actually used to the total amount of power which can be supplied from a commercial power source (such a proportion referred to as a usage rate of power) is low, power can be stored in the secondary battery, whereby the usage rate of power can be reduced in a time period when the electronic devices are used. For example, in the case of the electric refrigerator-freezer 530, power can be stored in the secondary battery 534 in nighttime when the temperature is low and the door for a refrigerator 532 and the door for a freezer 533 are not often opened and closed. On the other hand, in daytime when the temperature is high and the door for a refrigerator 532 and the door for a freezer 533 are frequently opened and closed, the secondary battery 534 is used as an auxiliary power source; thus, the usage rate of power in daytime can be reduced.

This embodiment can be implemented in combination with any of the other embodiments as appropriate.

### Embodiment 4

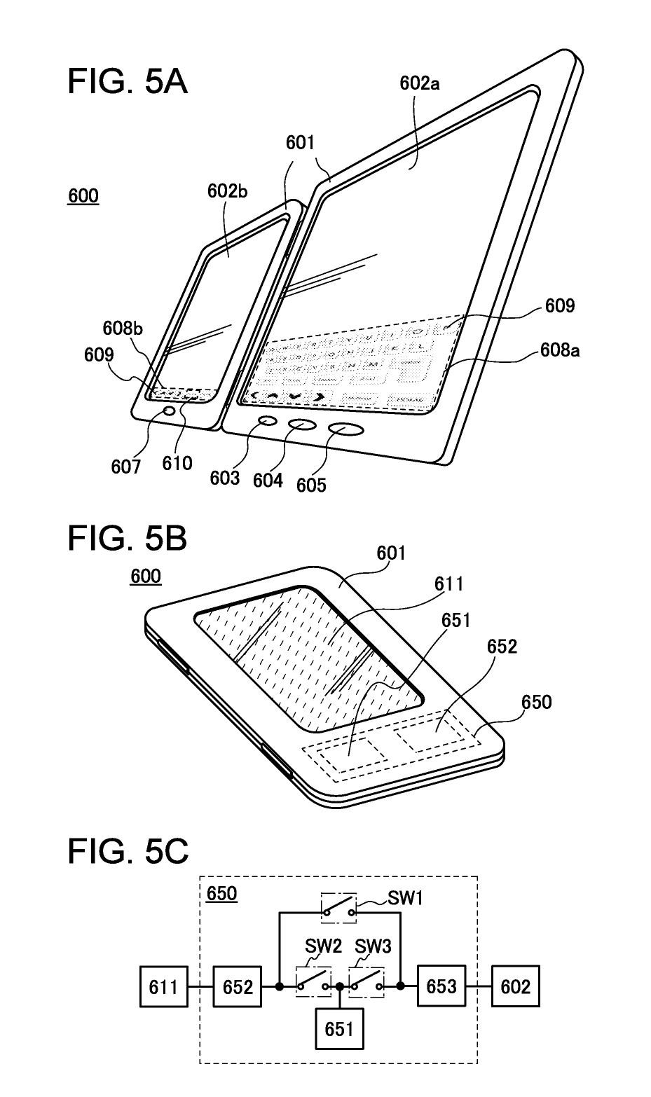

Next, a portable information terminal which is an example of a portable electronic device is described with reference to FIGS. 5A to 5C.

FIGS. 5A and 5B illustrate a tablet terminal 600 that can be folded. FIG. 5A illustrates the tablet terminal 600 in the state of being unfolded. The tablet terminal 600 includes a housing 601, a display portion 602a, a display portion 602b, a switch 603 for switching display modes, a power switch 604, a switch 605 for switching to power-saving mode, and an operation switch 607.

Part of the display portion 602a can be a touch panel region 608a and data can be input when a displayed operation key 609 is touched. Note that FIG. 5A illustrates, as an example, that half of the area of the display portion 602a has only a display function and the other half of the area has a touch panel function. However, the structure of the display portion 602a is not limited to this, and all the area of the display portion 602a may have a touch panel function. For example, all the area of the display portion 602a can display keyboard buttons and serve as a touch panel while the display portion 602b can be used as a display screen.

Like the display portion 602a, part of the display portion 602b can be a touch panel region 608b. When a finger, a stylus, or the like touches the place where a button 610 for switching to keyboard display is displayed in the touch panel, keyboard buttons can be displayed on the display portion 602b.

Touch input can be performed on the touch panel regions 608a and 608b at the same time.

The switch 603 for switching display modes can switch the display between portrait mode, landscape mode, and the like, and between monochrome display and color display, for example. With the switch 605 for switching to power-saving mode, the luminance of display can be optimized depending on the amount of external light at the time when the tablet terminal is in use, which is detected with an optical sensor incorporated in the tablet terminal. The tablet terminal may include another detection device such as a sensor for detecting orientation (e.g., a gyroscope or an acceleration sensor) in addition to the optical sensor.

Although the display area of the display portion 602a is the same as that of the display portion 602b in FIG. 5A, one embodiment of the present invention is not particularly limited thereto. The display area of the display portion 602a may be different from that of the display portion 602b, and further, the display quality of the display portion 602a may be different from that of the display portion 602b. For example, one of them may be a display panel that can display higher-definition images than the other.

FIG. 5B illustrates the tablet terminal 600 in the state of being closed. The tablet terminal 600 includes the housing 601, a solar cell 611, a charge and discharge control circuit 650, a battery 651, and a DCDC converter 652. Note that FIG. 5B illustrates an example in which the charge and discharge control circuit 650 includes the battery 651 and the DCDC converter 652, and the battery 651 includes the secondary battery of one embodiment of the present invention.

Since the tablet terminal 600 can be folded, the housing 601 can be closed when the tablet terminal 600 is not in use. Thus, the display portions 602a and 602b can be protected, thereby providing the tablet terminal 600 with excellent endurance and excellent reliability for long-term use.

The tablet terminal illustrated in FIGS. 5A and 5B can also have a function of displaying various kinds of data (e.g., a still image, a moving image, and a text image), a function of displaying a calendar, a date, the time, or the like on the display portion, a touch-input function of operating or editing data displayed on the display portion by touch input, a function of controlling processing by various kinds of software (programs), and the like.

The solar cell 611, which is attached on the surface of the tablet terminal 600, supplies power to the touch panel, the display portion, a video signal processor, and the like. Note that the solar cell 611 is preferably provided on one or two surfaces of the housing 601, in which case the battery 651 can be charged efficiently.

The structure and operation of the charge and discharge control circuit 650 illustrated in FIG. 5B are described with reference to a block diagram in FIG. 5C. The solar cell 611, the battery 651, the DCDC converter 652, a converter 653, switches SW1 to SW3, and the display portion 602 are illustrated in FIG. 5C, and the battery 651, the DCDC converter 652, the converter 653, and the switches SW1 to SW3 correspond to the charge and discharge control circuit 650 illustrated in FIG. 5B.

First, an example of the operation in the case where power is generated by the solar cell 611 using external light is described. The voltage of power generated by the solar cell 611 is raised or lowered by the DCDC converter 652 so that the power has a voltage for charging the battery 651. Then, when the power from the solar cell 611 is used for the operation of the display portion 602, the switch SW1 is turned on and the voltage of the power is raised or lowered by the converter 653 so as to be a voltage needed for the display portion 602. In addition, when display on the display portion 602 is not performed, the switch SW1 may be turned off and the switch SW2 may be turned on so that the battery 651 is charged.

Here, the solar cell 611 is described as an example of a power generation means; however, there is no particular limitation on the power generation means, and the battery 651 may be charged with another power generation means such as a piezoelectric element or a thermoelectric conversion element (Peltier element). For example, the battery 651 may be charged with a non-contact power transmission module that transmits and receives power wirelessly (without contact) to charge the battery or with a combination of other charging means.

It is needless to say that one embodiment of the present invention is not limited to the electronic device illustrated in FIGS. 5A to 5C as long as the electronic device is equipped with the secondary battery of one embodiment of the present invention which is described in any of the above embodiments.

### Embodiment 5

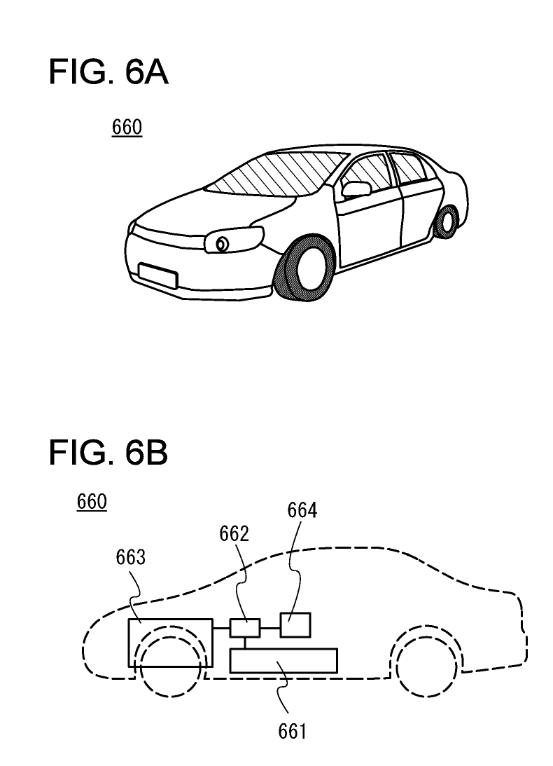

Further, an example of the moving object which is an example of the electronic device is described with reference to FIGS. 6A and 6B.

Any of the secondary battery described in any of the above embodiments can be used as a control battery. The control battery can be externally charged by electric power supply using a plug-in technique or contactless power feeding. Note that in the case where the moving object is an electric railway vehicle, the electric railway vehicle can be charged by electric power supply from an overhead cable or a conductor rail.

FIGS. 6A and 6B illustrate an example of an electric vehicle. An electric vehicle 660 is equipped with a battery 661. The output of the power of the battery 661 is adjusted by a control circuit 662 and the power is supplied to a driving device 663. The control circuit 662 is controlled by a processing unit 664 including a ROM, a RAM, a CPU, or the like which is not illustrated.

The driving device 663 includes a DC motor or an AC motor either alone or in combination with an internal-combustion engine. The processing unit 664 outputs a control signal to the control circuit 662 based on input data such as data on operation (e.g., acceleration, deceleration, or stop) by a driver of the electric vehicle 660 or data on driving the electric vehicle 660 (e.g., data on an upgrade or a downgrade, or data on a load on a driving wheel). The control circuit 662 adjusts the electric energy supplied from the battery 661 in accordance with the control signal of the processing unit 664 to control the output of the driving device 663. In the case where the AC motor is mounted, although not illustrated, an inverter which converts direct current into alternate current is also incorporated.

The battery 661 can be charged by external electric power supply using a plug-in technique. For example, the battery 661 is charged through a power plug from a commercial power source. The battery 661 can be charged by converting external power into DC constant voltage having a predetermined voltage level through a converter such as an AC-DC converter. When the secondary battery of one embodiment of the present invention is provided as the battery 661, capacity of the battery 661 can be increased and improved convenience can be realized. When the battery 661 itself can be made compact and lightweight with improved characteristics of the battery 661, the vehicle can be made lightweight, leading to an increase in fuel efficiency.

Note that it is needless to say that one embodiment of the present invention is not limited to the electronic devices described above as long as the secondary battery of one embodiment of the present invention is included.

This embodiment can be implemented in combination with any of the other embodiments as appropriate.

### EXAMPLE 1

One embodiment of the present invention is specifically described below with examples. Note that the present invention is not limited to the examples below.

### (Fabrication of Negative Electrode)

First, a negative electrode was fabricated as follows. Titanium foil with a thickness of 15 μm was used as a negative electrode current collector. Silicon particles (average particle size of 60 nm) as a particulate negative electrode active material, graphene oxide, and polyimide (more precisely, a precursor of polyimide) as a binder were mixed at a ratio of 40:40:20 (weight percent) to form slurry. Specifically, 0.08 g of silicon particles, 0.08 g of graphene oxide, and 0.292 g of a precursor of polyimide were mixed to form the slurry. Note that 13.7% of the precursor of polyimide was imidized through a heating step to be polyimide. That is, the weight of the precursor imidized to be polyimide was 0.04 g (0.292 g×0.137).

Next, heat treatment was performed to bake the slurry and to reduce graphene oxide. The heat treatment was performed at 120° C. for 0.5 hours and then, the temperature was increased to 250° C. and the heat treatment was performed at 250° C. for 0.5 hours. Then, the temperature was increased to 300° C., and the heat treatment was performed at 300° C. for 1 hour.

Through the above steps, a plurality of Negative Electrodes A, which was used in this example, was fabricated.

### (Manufacture of Cell)

The plurality of Negative Electrodes A fabricated as described above was used to manufacture a variety of half cells. Coin cells were used as the half cells. Metallic lithium was used for positive electrodes. Cellulose was used for separators (note that a glass fiber separator was used in Cell C which is described later and in which an ionic liquid is used as an electrolyte solution).

The half cell including Negative Electrode A fabricated as described above, the positive electrode formed of metallic lithium, and an electrolyte solution in which lithium perchlorate (LiClO₄) was contained as an electrolyte in propylene carbonate (PC) that is a nonaqueous solvent is referred to as Cell A.

The half cell including Negative Electrode A, the positive electrode formed of metallic lithium, and an electrolyte solution in which lithium hexafluorophosphate (LiPF₆) was contained as an electrolyte in propylene carbonate (PC) that is a nonaqueous solvent is referred to as Cell B.

The half cell including Negative Electrode A, the positive electrode formed of metallic lithium, and an electrolyte solution in which lithium bis(trifluoromethylsulfonyl)amide (LiTFSA) was contained as an electrolyte in an ionic liquid, 1-methyl-1-propylpyrrolidinium bis(fluorosulfonyl)amide (P13-FSA), that is a nonaqueous solvent is referred to as Cell C.

The half cell including Negative Electrode A, the positive electrode formed of metallic lithium, and an electrolyte solution in which lithium perchlorate (LiClO₄) was contained as an electrolyte in a mixed solution of ethylene carbonate (EC) and diethyl carbonate (DEC), which is a nonaqueous solvent, is referred to as Cell D. The ethylene carbonate (EC) and the diethyl carbonate (DEC) were mixed at a volume ratio of 1:1.

### (Measurement of Cycle Performance)

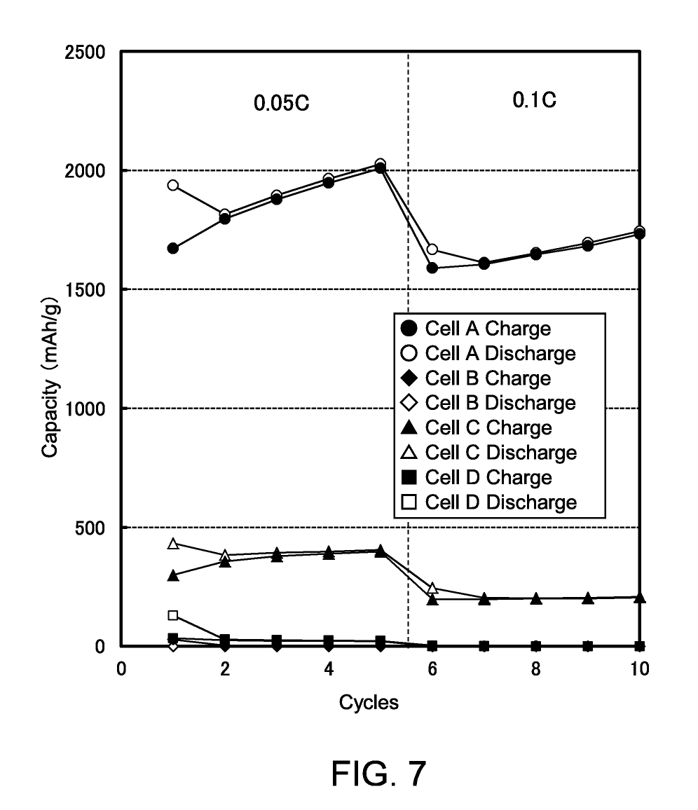

Cycle performance in a low temperature environment at −25° C. (minus 25° C.) of each of Cells A to D manufactured as described above is shown in FIG. 7.

In FIG. 7, the horizontal axis represents the number of repeated charges and discharges (the number of cycles) and the vertical axis represents discharge capacity (mAh/g). In FIG. 7, the black circles represent the charge capacity of Cell A; the white circles, the discharge capacity of Cell A; the black rhombuses, the charge capacity of Cell B; the white rhombuses, the discharge capacity of Cell B; the black triangles, the charge capacity of Cell C; the white triangles, the discharge capacity of Cell C; the black squares, the charge capacity of Cell D; and the white squares, the discharge capacity of Cell D.

The measurement was performed with the use of a thermostated bath in a low temperature environment at −25° C. All Cells were charged and discharged at a charging and discharging rate of 0.05 C from the first cycle to the fifth cycle, and charged and discharged at a charging and discharging rate of 0.1 C in the sixth and the subsequent cycles. Here, the charging and discharging rate C refers to a rate at which a battery is charged and discharged and is represented by “current (A)÷capacity (Ah)”. For example, 1 C is to charge and discharge a battery having a capacity of 1 Ah with 1 A, and 10 C is to charge and discharge the battery with 10 A. The initial charges and discharges at 0.05 C and the subsequent charges and discharges at 0.1 C were not performed by constant current-constant voltage (CC-CV) charge and discharge but performed only by constant current (CC) charge and discharge.

Charge capacity and discharge capacity were measured, and the charge capacities and discharge capacities with respect to the number of cycles were plotted. There is almost no difference between the values of the charge capacity and discharge capacity of each of the cells and curves of all the cells are similar to each other.

It has been found that Cell A, in which propylene carbonate (PC) containing lithium perchlorate (LiClO₄) was used as the electrolyte solution, has charge and discharge capacity higher than those of the other cells. This result can be obtained at both the charging and discharging rates of 0.05 C and 0.1 C.

On the other hand, it has been found that charge and discharge capacity of each of the other cells is not at the same level as that of Cell A.

It has been found that although being lower than that of Cell A, the charge and discharge capacity was formed in Cell C, in which the ionic liquid P13-FSA containing LiTFSA was used as the electrolyte solution, in the low temperature environment at −25° C.

Charge and discharge capacity was hardly formed in either Cell B, in which propylene carbonate (PC) containing lithium hexafluorophosphate (LiPF₆) was used as the electrolyte solution, or Cell D, in which the mixed solution of ethylene carbonate (EC) and diethyl carbonate (DEC) containing lithium perchlorate (LiClO₄) was used as the electrolyte solution.

The above measurement results of Cells A to D show that in a battery cell using Negative Electrode A, propylene carbonate (PC) containing lithium perchlorate (LiClO₄) is the most suitable electrolyte solution.

On the other hand, even when propylene carbonate (PC) is used as the nonaqueous solvent in Cell B as in Cell A, Cell B including the electrolyte solution in which lithium hexafluorophosphate (LiPF₆) is used as the electrolyte cannot have performance at the same level as that of Cell A. Further, even when lithium perchlorate (LiClO₄) is used as the electrolyte in Cell D as in Cell A, Cell D including the electrolyte solution in which the mixed solution of ethylene carbonate (EC) and diethyl carbonate (DEC) is used as the nonaqueous solvent cannot have performance at the same level as that of Cell A.

As a result, it has been revealed that a combination of Negative Electrode A including graphene and an electrolyte solution containing propylene carbonate (PC) as a nonaqueous solvent and lithium perchlorate (LiClO₄) as an electrolyte is preferable. The use of such an electrolyte and a nonaqueous solvent with Negative Electrode A enables Negative Electrode A to have maximum battery performance and enables a secondary battery having battery performance particularly in a low temperature environment at −25° C. to be manufactured. In addition, charge and discharge can be performed satisfactorily in a low temperature environment only by the CC charge and discharge.

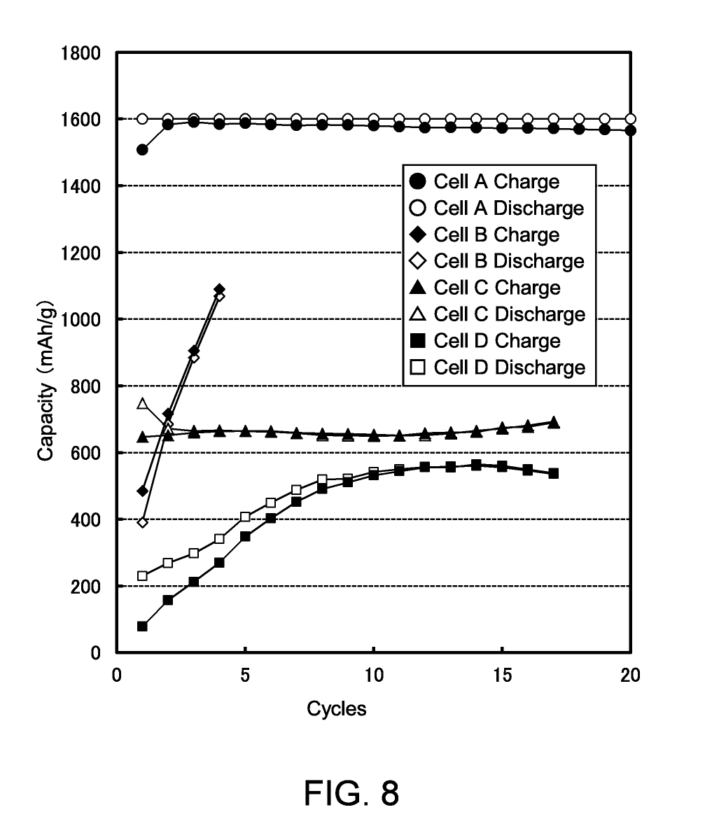

Next, FIG. 8 shows measurement results of cycle performance in a low temperature environment at −25° C. in the case of charge and discharge by the CC-CV charge and discharge. Cells A to D were measured in a manner similar to that in the above-described charge and discharge performed only by the CC charge and discharge.

In FIG. 8, the horizontal axis represents the number of repeated charges and discharges (the number of cycles) and the vertical axis represents discharge capacity (mAh/g). In FIG. 8, the black circles represent the charge capacity of Cell A; the white circles, the discharge capacity of Cell A; the black rhombuses, the charge capacity of Cell B; the white rhombuses, the discharge capacity of Cell B; the black triangles, the charge capacity of Cell C; the white triangles, the discharge capacity of Cell C; the black squares, the charge capacity of Cell D; and the white squares, the discharge capacity of Cell D.

In the CC-CV charge and discharge, the CC charge and discharge at 0.2 C were performed to insert (or extract) Li to 0.03 V, and then CV charge and discharge were performed so that the total time spent of the whole CC-CV charge and discharge is 20 hours.

The curve showing discharge capacity and the curve showing charge capacity of each of Cells A to D roughly overlap each other. Even in the CC-CV charge and discharge, Cell A in which propylene carbonate (PC) containing lithium perchlorate (LiClO₄) was used as the electrolyte solution has charge and discharge capacity higher than those of the other cells.

Cells B to D each have charge and discharge capacity in a low temperature environment at −25° C., which is higher than those of Cells B to D charged and discharged only by the CC charge and discharge as shown in FIG. 7.

### EXAMPLE 2

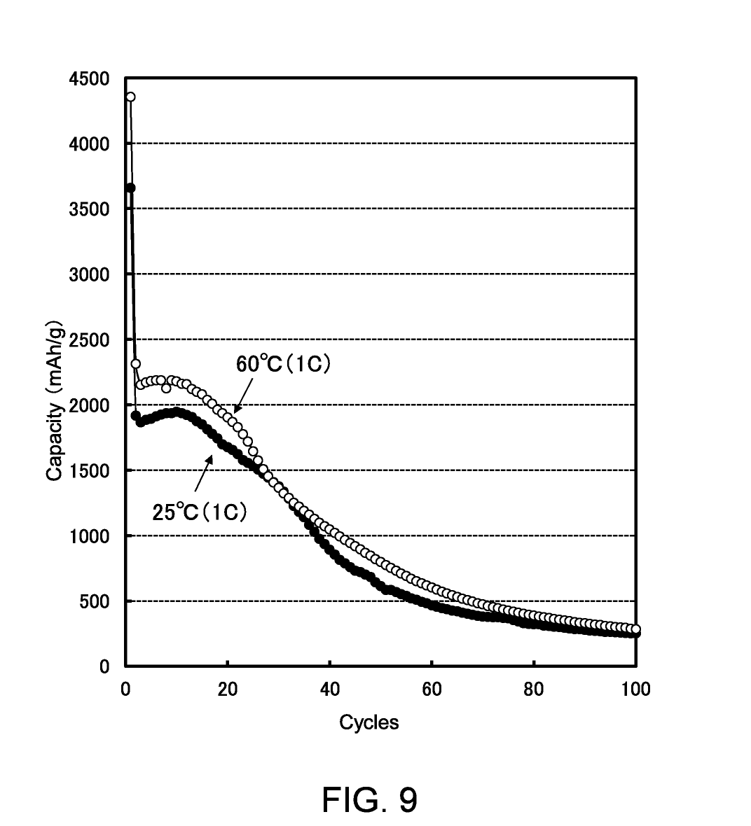

In this example, cycle performance at room temperature and cycle performance at high temperature of Cell A manufactured in Example 1 are described with reference to FIG. 9.

Cell A manufactured in Example 1 was used in the measurement of the cycle performance. Cycle performance of discharge capacity at a room temperature of 25° C. and cycle performance of discharge capacity at a high temperature of 60° C. were measured.

In FIG. 9, the horizontal axis represents the number of repeated charges and discharges (the number of cycles) and the vertical axis represents discharge capacity (mAh/g). In FIG. 9, the black circles represent the discharge capacity at the room temperature (25° C.) and the white circles represent the discharge capacity at the high temperature (60° C.). Charge and discharge were performed at a rate of 1 C.

The measurement results show that the discharge capacity was formed at both the room temperature and the high temperature, and Cell A functions as a battery. The discharge curves at the room temperature and the high temperature are substantially similar to each other.

### EXAMPLE 3

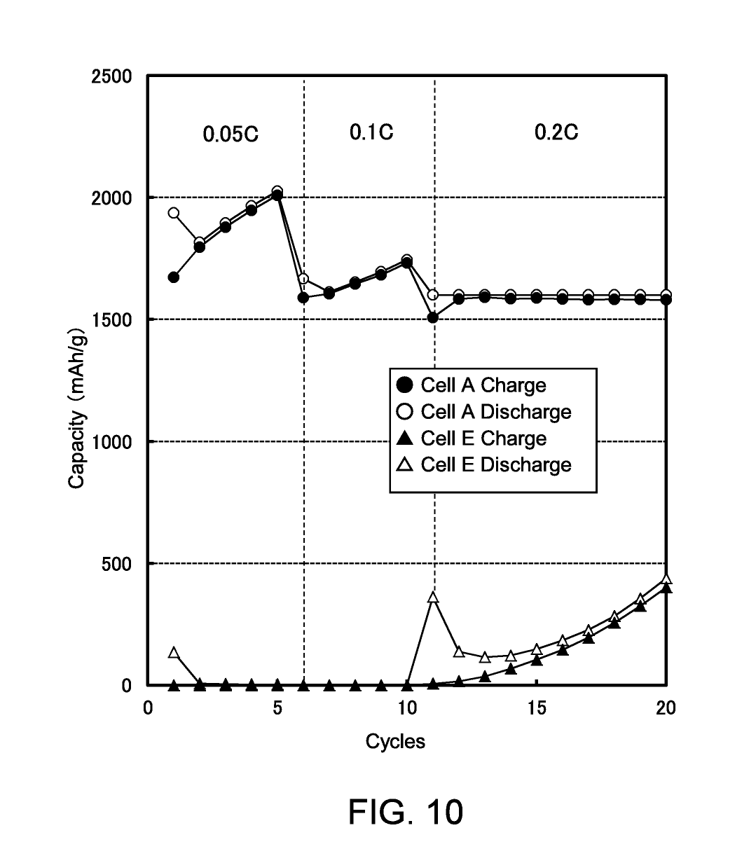

In this example, Negative Electrode B was fabricated with the use of ketjen black particles that are a conventional conductive additive instead of graphene oxide which was used as a raw material of the conductive additive in Negative Electrode A manufactured in Example 1. A method for fabricating Negative Electrode B was similar to that of Negative Electrode A using graphene oxide which is described in Example 1. Baking was performed at 300° C. for 1 hour. Measurement results of cycle performance of a half cell including Negative Electrode A (Cell A) and cycle performance of a half cell including Negative Electrode B (Cell E) are described with reference to FIG. 10.

First, Negative Electrode B was fabricated in the following manner. Titanium foil with a thickness of 15 μm was used as a negative electrode current collector. For a negative electrode active material layer, silicon particles (average diameter of 60 nm) similar to those used in Negative Electrode A, ketjen black particles, and polyimide similar to that used in Negative Electrode A were mixed at a ratio of 80:5:15 (weight percent) to form slurry. The slurry was applied to the negative electrode current collector and baked at 300° C. for 1 hour, and Negative Electrode B was fabricated. The ketjen black particles which were used have a hollow structure with a percentage of voids of approximately 80%, primary particles with a diameter of approximately 34 nm, and a BET specific surface area of approximately 1270 m²/g.

As described in Example 1, the half cell including Negative Electrode A, a positive electrode formed of metallic lithium, and an electrolyte solution in which lithium perchlorate (LiClO₄) was contained as an electrolyte in propylene carbonate (PC) that is a nonaqueous solvent is Cell A.

The half cell including Negative Electrode B, a positive electrode formed of metallic lithium, and an electrolyte solution in which lithium perchlorate was contained as an electrolyte in propylene carbonate that is a nonaqueous solvent is Cell E.

Cellulose was used as separators in Cell A and Cell E. That is, Cell A and Cell E have different negative electrodes, Negative Electrode A and Negative Electrode B respectively, and have the same structure other than the negative electrodes. An electrolyte solution in which lithium perchlorate (LiClO₄) was contained as an electrolyte in propylene carbonate (PC) that is a nonaqueous solvent was used.

In FIG. 10, the horizontal axis represents the number of repeated charges and discharges (the number of cycles) and the vertical axis represents discharge capacity (mAh/g). The measurement temperature was −25° C. In FIG. 10, the black circles represent the charge capacity of Cell A; the white circles, the discharge capacity of Cell A; the black triangles, the charge capacity of Cell E; and the white triangles, the discharge capacity of Cell E. Both of the cells were charged and discharged at a charging and discharging rate of 0.05 C from the first cycle to the fifth cycle and at a charging and discharging rate of 0.1 C from the sixth cycle to the tenth cycle only by the CC charge and discharge. In the eleventh and the subsequent cycles, the both of the cells were charged and discharged by the CC-CV charge and discharge in which the CC charge and discharge and the CV charge and discharge were performed at a rate of 0.2 C for 20 hours.

As a result, FIG. 10 shows that high charge and discharge capacity was formed in Cell A even in a low temperature environment at −25° C., whereas charge and discharge capacity was not formed in Cell E during the CC charge and discharge performed from the first cycle to the tenth cycle.

When the CC-CV charge and discharge were performed (i.e., in the eleventh and the subsequent cycles), charge and discharge capacity was formed little by little in Cell E.

As described above, in the charge and discharge only performed by the CC charge and discharge (first to tenth cycles), charge and discharge capacity greatly varies with the material of the conductive additive in the negative electrode even when an electrolyte solution in which lithium perchlorate was contained as an electrolyte in propylene carbonate that is a nonaqueous solvent was used. Therefore, instead of a conventional particulate conductive additive, graphene whose raw material is graphene oxide, which is used in one embodiment of the present invention, is preferably used as a conductive additive of a negative electrode.

### EXAMPLE 4

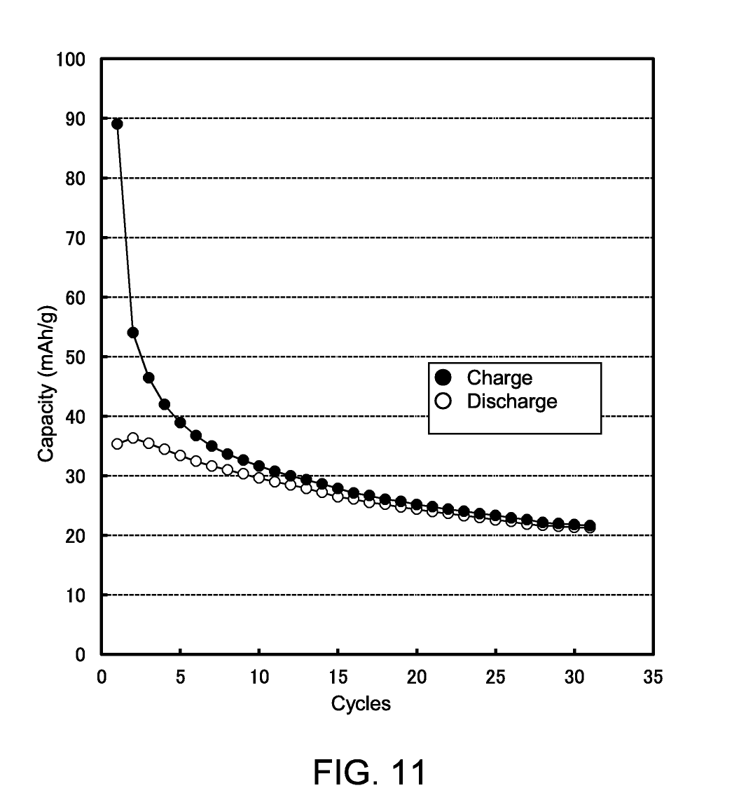

In this example, battery performance of a coin-type full cell including Negative Electrode A described in Example 1 is described with reference to FIG. 11.

Negative Electrode A described in Example 1 was used as a negative electrode. In a positive electrode, a mixture of LiFePO₄ that is a positive electrode active material, acetylene black (AB), and PVDF was applied to a positive electrode current collector and baked to form a positive electrode active material layer. The mixture ratio of the materials of the positive electrode active material layer was LiFePO₄:AB:PVDF=85:8:7. The baking was performed at 135° C. for 2 hours with a vacuum dryer.

The cell was assembled with a space between the positive electrode and the negative electrode filled with an electrolyte solution in which lithium perchlorate (LiClO₄) was contained as an electrolyte in propylene carbonate (PC) that is a nonaqueous solvent. Cellulose was used as a separator.

In FIG. 11, the horizontal axis represents the number of repeated charges and discharges (the number of cycles) and the vertical axis represents discharge capacity (mAh/g). In FIG. 11, the black circles illustrate the charge capacity, and the white circles illustrate the discharge capacity. Measurement was performed in a low temperature environment at −25° C. The CC-CV charge and discharge (a charging and discharging rate of the negative electrode corresponds to 0.095 C in the CC charge and discharge) were performed for 20 hours in total.

FIG. 11 shows that a battery with the full cell structure exhibits battery performance in a low temperature environment at −25° C.

This application is based on Japanese Patent Application serial No. 2012-146716 filed with Japan Patent Office on Jun. 29, 2012, the entire contents of which are hereby incorporated by reference.

What is claimed is:

1. A secondary battery comprising:
a positive electrode,
a negative electrode comprising an active material layer, the active material layer comprising:
graphene;
a binder; and
an active material comprising a plurality of particles, and
an electrolyte solution, the electrolyte solution comprising:
propylene carbonate; and
lithium perchlorate,
wherein the plurality of particles contain an alloy-based material.

2. The secondary battery according to claim 1,
wherein the negative electrode further comprises a current collector, and
wherein the active material layer is provided over the current collector.

3. The secondary battery according to claim 1,
wherein the plurality of particles are surrounded by the graphene.

4. The secondary battery according to claim 1,
wherein the plurality of particles are surrounded by the graphene, and
wherein the graphene has a sheet-like shape.

5. The secondary battery according to claim 1,
wherein the alloy-based material contains at least one of Mg, Ca, Al, Ge, Sn, Pb, As, Sb, Bi, Ag, Au, Zn, Cd, and Hg.

6. A secondary battery comprising:
a positive electrode,
a negative electrode comprising an active material layer, the active material layer comprising:
graphene;
a binder; and
an active material comprising a plurality of particles, and
an electrolyte solution, the electrolyte solution comprising:
propylene carbonate; and
lithium perchlorate,
wherein the plurality of particles contain silicon.

7. The secondary battery according to claim 6,
wherein the negative electrode further comprises a current collector, and
wherein the active material layer is provided over the current collector.

8. The secondary battery according to claim 6,
wherein the plurality of particles are surrounded by the graphene.

9. The secondary battery according to claim 6,
wherein the plurality of particles are surrounded by the graphene, and
wherein the graphene has a sheet-like shape.

10. A secondary battery comprising:
a positive electrode,
a negative electrode comprising an active material layer, the active material layer comprising:
graphene;
a binder; and
an active material comprising a plurality of particles, and
an electrolyte solution, the electrolyte solution comprising:
propylene carbonate; and
lithium perchlorate,
wherein the plurality of particles contain silicon, and
wherein the binder contains polyimide.

11. The secondary battery according to claim 10,
wherein the negative electrode further comprises a current collector, and
wherein the active material layer is provided over the current collector.

12. The secondary battery according to claim 10,
wherein the plurality of particles are surrounded by the graphene.

13. The secondary battery according to claim 10,
wherein the plurality of particles are surrounded by the graphene, and
wherein the graphene has a sheet-like shape.
